(19) United States
(12) Patent Application Publication
(10) Pub. No.: US 2009/0140226 A1
(43) Pub. Date: Jun. 4, 2009

(54) PVC GATE ASSEMBLY

(75) Inventor: Edward J. Stull, Oxford, MI (US)

Correspondence Address: CARLSON, GASKEY & OLDS, P.C., 400 WEST MAPLE ROAD, SUITE 350, BIRMINGHAM, MI, 48009, US

(73) Assignee: Turnstyle Intellectual Property, LLC, Georgetown, SC (US)

(21) Appl. No.: 12/325,369

(22) Filed: Dec. 1, 2008

Related U.S. Application Data
(60) Provisional application No. 60/991,345, filed on Nov. 30, 2007.

(51) Int. Cl. E04H 17/14; E04H 17/24; E04H 17/20; E06B 11/02

(52) U.S. Cl. 256/19; 256/73; 256/65.05

(57) ABSTRACT

A plastic gate assembly includes a plurality of rails that extend between a support post assembly and a latch rail. The gate assembly utilizes commonly available PVC rail components with the disclosed inventive PVC brackets to build a gate assembly. The post assembly includes a D-shaped profile to provide a desired clearance between the rotating support post assembly and a corresponding adjacent fixed fence post.

### CROSS REFERENCE TO RELATED APPLICATION

The application claims priority to U.S. Provisional Application No. 60/991,345 which was filed on Nov. 30, 2007.

### BACKGROUND OF THE INVENTION

This disclosure generally relates to a gate assembly fabricated from plastic components. More particularly this invention relates to adaptors and connectors for constructing a plastic gate assembly with common plastic rails.

Typical plastic fences are constructed utilizing prefabricated rails and posts. The plastic material is typically a polyvinyl chloride material commonly referred to as PVC. The posts typically include slots within which each rail is received. The posts are constructed of PVC, but are not sufficiently stable to support the cantilevered weight of a gate assembly as the typical post and rail for a fence are not intended for use in gate construction. Accordingly, construction of a gate assembly that matches the PVC fence typically requires reinforcing materials such as aluminum or wood that is covered with PVC material.

### SUMMARY OF THE INVENTION

A disclosed plastic gate assembly includes a plurality of rails that extend between a support post assembly and a latch rail. The disclosed gate assembly utilizes commonly available PVC rail components attached and assembled to each other with the disclosed inventive PVC brackets and support post brackets. The example post assembly includes a D-shaped profile to provide a desired clearance between the rotating support post assembly and a corresponding adjacent fixed fence post.

The disclosed example gate assembly is constructed entirely with PVC components and does not require additional reinforcing components such as metal or wood. The gate assembly includes D-shaped gate brackets that fit over a D-shaped support post. D-shaped spacers distance the D-shaped gate brackets from each other.

The D-shaped profile of the support post assembly provides for a close non-pinch operation adjacent a static post by providing continuous spacing between a static post and the rotating support post assembly throughout rotation of the gate assembly.

Further, the inventive connectors provide for easy assembly of a gate structure from commonly available PVC rails utilized for fencing.

### BRIEF DESCRIPTION OF THE DRAWINGS

FIG. 1 is a perspective view of an example PVC gate assembly.

FIG. 2 includes several views of an example D-shaped Gate bracket.

FIG. 3 includes several views of an example rail to latch post bracket.

FIG. 4 includes several views of an example rail to mid latch post bracket.

FIG. 5 is a cross-sectional view of a D-shaped spacer.

FIG. 6 includes cross-sectional views of a D-shaped driven support post.

FIG. 7 includes several views of top support post bracket.

FIG. 8 includes several views of a bottom support post journal.

FIG. 9 is a cross-sectional view of an example support post assembly.

### DETAILED DESCRIPTION OF THE PREFERRED EMBODIMENT

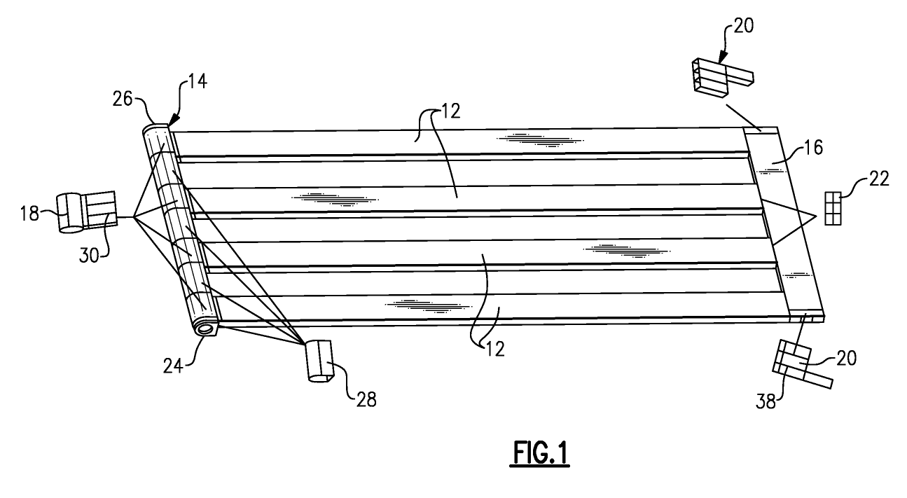

Referring to FIG. 1, a plastic gate assembly 10 includes a plurality of rails 12 that extend between a support post assembly 14 and a latch rail 16. The example gate assembly 10 is fabricated from thermoplastic materials such as polyvinyl chloride, commonly referred to as PVC. The gate assembly utilizes commonly available PVC rail components with the disclosed inventive PVC brackets and support post brackets. The example inventive support post assembly includes a D-shaped profile to provide a desired clearance between the rotating support post assembly and a corresponding adjacent fixed fence post.

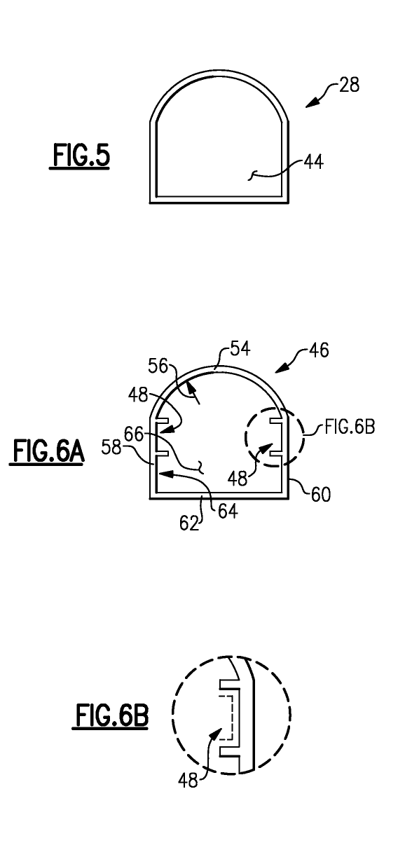

The gate assembly 10 is constructed entirely with PVC components and does not require additional reinforcing components such as metal or wood. The gate assembly 10 includes D-shaped gate brackets 18 that fit over a D-shaped support post 46 (Best shown in FIG. 6). D-shaped spacers 28 distance the D-shaped gate brackets 18 from each other. The D-shaped gate brackets 18 include male adaptor members 30 received in the hollow interior of each rail 12.

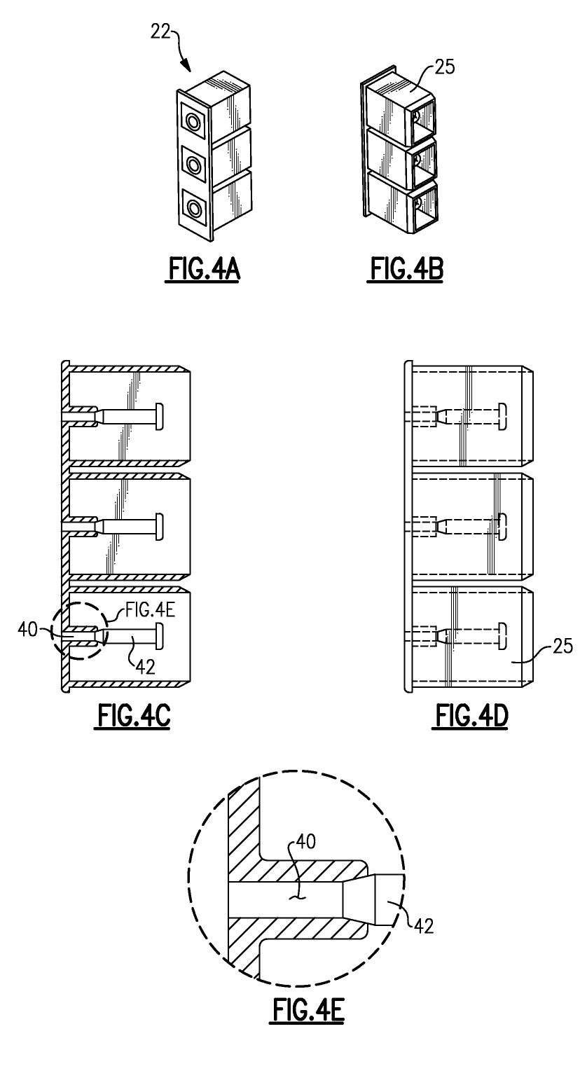

The latch rail 16 is attached to the rails 12 at a top and bottom by a latch post bracket 20. The latch post bracket 20 includes male adaptor members 38 that are received within the rails 12 like the members 30 of the D-shaped gate brackets 18. Each of the latch post brackets 20 include a rail cap 36 that receives corresponding ends of the latch rail 16. Note that the latch rail 16 is simply a common rail extrusion cut to a desired length. The top and bottom rails 12 are attached to the latch rail 16 by way of the brackets 20. The middle two rails 12 are attached to the latch rail 16 by way of mid latch brackets 22. The mid latch brackets 22 include members 25 (FIG. 4) received within the corresponding rail 12. The mid latch brackets 22 are secured to an exterior surface of the latch rail 16 by way of threaded fasteners 42. Although threaded fasteners are disclosed, other fastening means such as adhesive, rivets or other known methods and fasteners are within the contemplation of this invention.

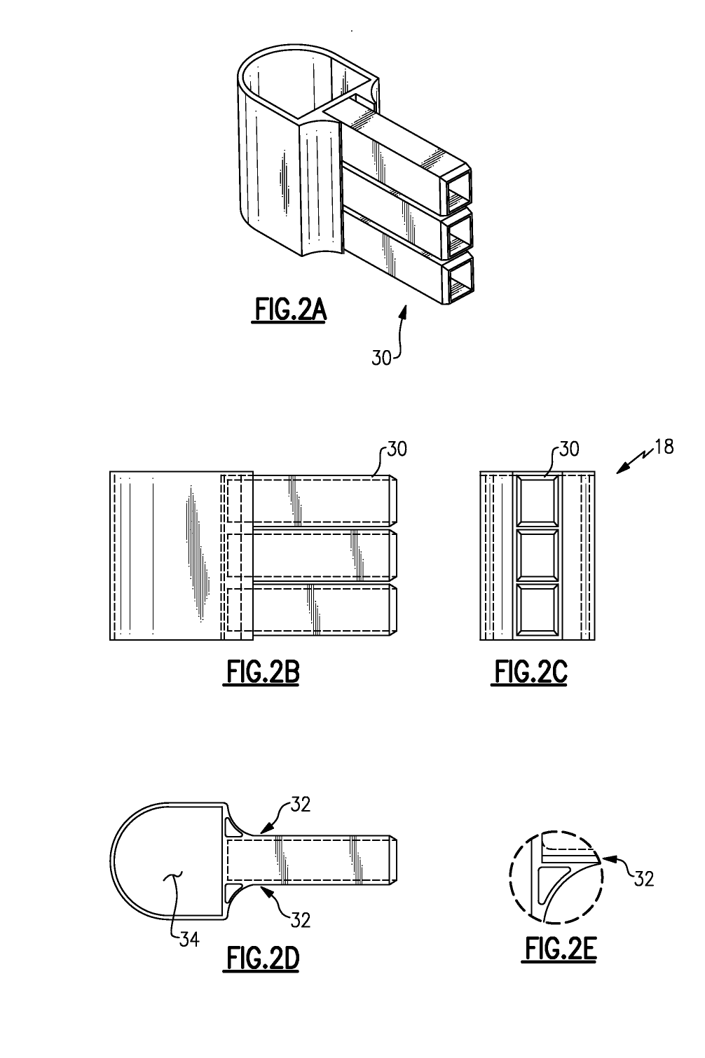

Referring to FIG. 2, the D-shaped gate brackets 18 include an opening 34. The opening provides for mounting of the bracket 18 to the similarly shaped support post 46. The members 30 are inserted into the hollow rails 12. A slot 32 is disposed on either side of the members 30 to receive the rail 12 and provide an aesthetically pleasing appearance while also strengthening the connection therebetween. The rails 12 can be secured to each of the brackets with know adhesives commonly utilized in construction of a PVC fence.

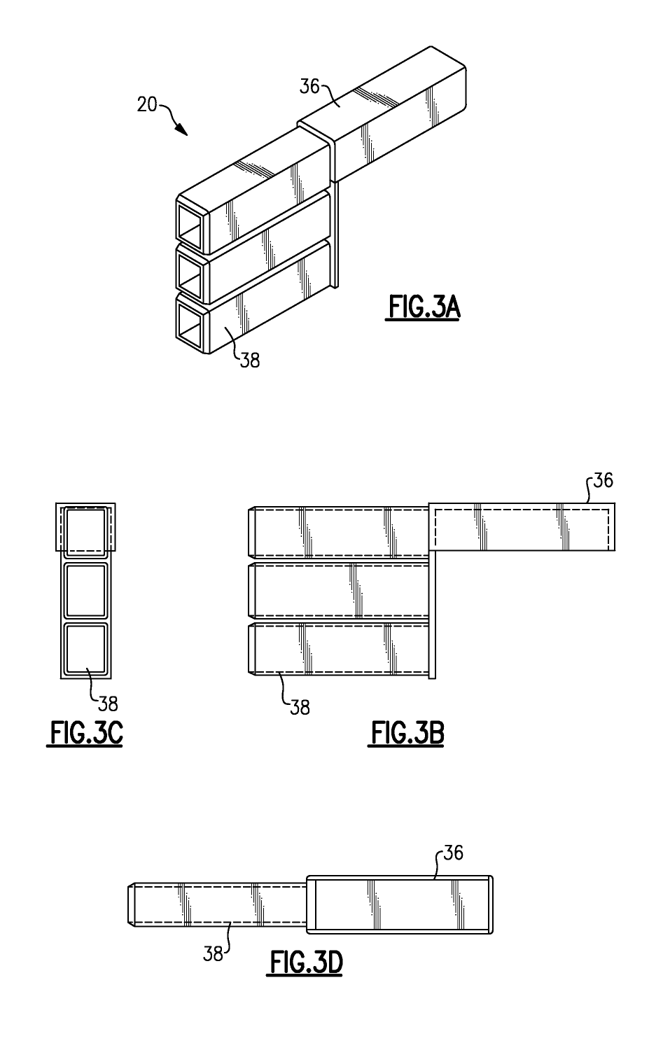

Referring to FIG. 3, the latch post brackets 20 include the members 38 that are received and secured within a corresponding rail 12. The latch post brackets 20 are utilized at the top and bottom rails 12. The latch rail 16 is received within a cavity formed in caps 36 that extend from the members 38 to provide a transverse connection between the rails 12 and the latch rail 16.

Referring to FIG. 4, the rails 12 that are disposed between the top and bottom rails 12 are attached to the latch rail 16 with the mid latch rail brackets 22. The mid rail brackets 22 include the member 25 that are received within the rail 12. The rail brackets 22 are secured to the latch rail 16 with threaded fasteners 42 that extend through an opening 40. The brackets 22 are first mounted to the desired position on the latch rail 16. The desired rail 12 is then inserted onto the members 25 and secured with adhesive or other known methods.

Referring to FIGS. 2, 5 and 6, the support post assembly 14 includes the support post 46 that extends the height of the gate assembly 10. The brackets 18 are slide over the support post 46 and alternated with the spacers 28 to provide the desired spacing between rails 12. As appreciated the spacing and number of rails 12 can be modified as is desired by adjustment of the length of the spacers 28.

The spacers 28 include a common D-shaped profile sized to fit over the outer surface of the support post 46. Accordingly, inner space 44 is open and matches the outer dimensions of the support post 46.

The D-shaped profile of the support post assembly 14 provides for a close non-pinch operation adjacent a static post. The D-shaped profile provides a continuous spacing between a static post and the rotating support post assembly throughout rotation of the gate assembly 10. Accordingly, the rotating post can be placed closer to the fixed post without creating a pinch hazard. Further, the D-shaped profile can transfer driven movement to the gate if the post assembly 14 is equipped with an automatic opening mechanism.

Referring to FIG. 6, the D-shaped support post 46 includes drive channels 48 within a cavity 66 that can receive a driven member 72 (FIG. 6) for rotating the gate between open and closed positions responsive to operation of a gate opening mechanism. The drive channels 48 are disposed opposite each other. Further, each of the drive channels 48 comprise first and second tab portions 49 that extend upward perpendicular to an inner surface 64 of the support post 46. The D-shaped support post 46 includes a curvilinear side 54 with a constant radius 56. The curvilinear side 54 extends from first and second parallel sides 58, 60. A third side 62 is attached to the first and second parallel sides 58, 60 and opposite the curvilinear side 54.

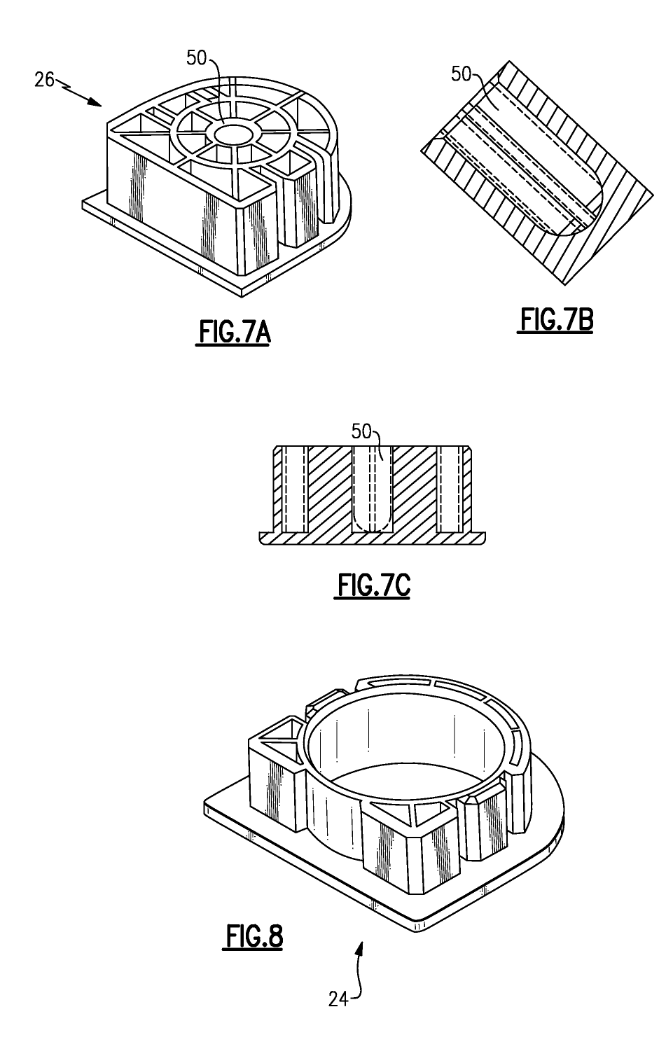

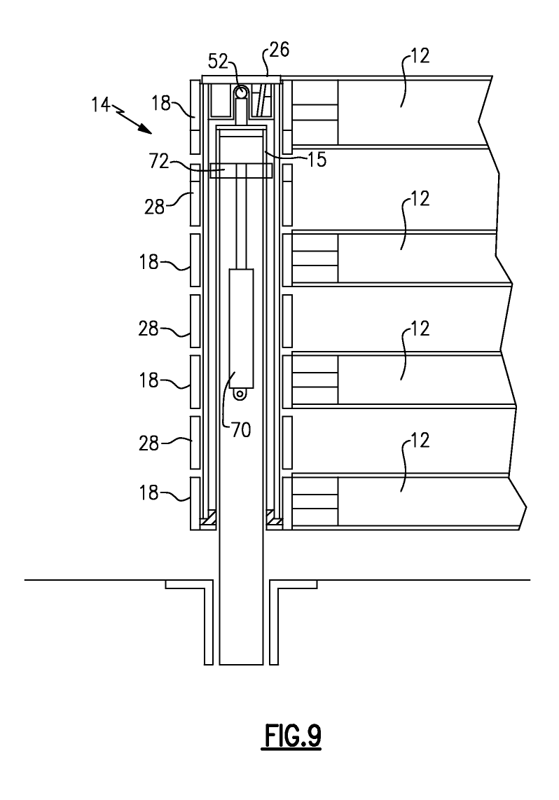

Referring to FIGS. 7-9, the post assembly 14 includes a top cap 26 and a bottom journal 24 that facilitate rotation of the gate assembly 10. The top cap 26 fits onto the support post 46 and can receive a support bearing 52 within a bore 50 on which the gate rotates. The top cap 26 includes features keyed to fit the support post 46. The bottom journal 24 includes features keyed to the support post 46 and abuts an inner fixed support post 15 on which the gate assembly 10 is mounted and supported for rotation.

Referring to FIG. 9, optionally, the gate assembly 10 can include an actuator 70 mounted within the fixed support post 15. The actuator 70 drives the driven member 72 to facilitate rotation of the rotatable post 46. The driven member 72 is disposed within drive grooves 48 integrally formed on the inner surface 64 of the rotatable post 46 (Best shown in FIG. 6).

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A gate assembly fabricated from a plastic material comprising:
a rotatable post supportable for rotation on a fixed support post;
a latch rail disposed parallel with the rotatable post and spaced horizontally from the rotatable post;
at least one rail extending horizontally between the rotatable post and the latch rail; and
at least one connector disposed on each end of the at least one rail for attaching the corresponding rail to the rotatable post and the latch rail.

2. The assembly as recited in claim 1, wherein the at least one connector comprise a first connector that slides over the rotatable post and includes an interface portion received within a corresponding end of the rail.

3. The assembly as recited in claim 2, including a second connector that includes a portion received within the rail and an opening for a fastener that extends through the second connector and into the latch rail such that the rail is secured to the latch rail.

4. The assembly as recited in claim 1, including a bearing supported on a post between the fixed support post and the rotatable post to facilitate relative rotation therebetween.

5. The assembly as recited in claim 1, including a top cap attached to the support post including a cavity for receiving the bearing.

6. The assembly as recited in claim 5, wherein the fixed post includes the post and the bearing and post are received at least partially within the cavity of the top cap.

7. The assembly as recited in claim 2, wherein the rotatable post comprises a D-shaped portion for providing a continuous spacing relative to an adjacent fixed post.

8. The assembly as recited in claim 7, wherein the first connector includes a D-shaped profile that fits over the D-shaped outer profile of the rotatable post.

9. The assembly as recited in claim 8, including a plurality of rails and a corresponding plurality of first connectors spaced apart by at least one spacer.

10. The assembly as recited in claim 1, wherein the rotatable post includes a drive slot for receiving a driven member to rotate the gate assembly.

11. A connector for securing plastic fence components together, the connector comprising:
an adaptor member receivable within an inner space of a fence component; and
an attachment portion attachable to a vertical fence component.

12. The connector as recited in claim 11, wherein the attachment portion comprises a hollow inner space adapted to fit over a vertical fence component, wherein the adaptor member extends from the attachment portion.

13. The connector as recited in claim 11, wherein the attachment portion comprises openings through which extend fasteners for securing the attachment portion to a fence component.

14. The connector as recited in claim 11, wherein the attachment portion comprises a D-shaped inner cavity.

15. A plastic fence post comprising:
a cross-sectional shape comprising a curvilinear side of a constant radius extending from first and second parallel sides.

16. The plastic fence post as recited in claim 16, including a third side transverse to the first and second parallel sides and opposite the curvilinear side.

17. The plastic fence post as recited in claim 15, including an inner cavity including an inner surface, wherein the inner surface includes at least one drive feature extending from the inner surface into the inner cavity.

18. The plastic fence post as recited in claim 17, wherein the at least one drive features comprises first and second grooves disposed across from each other within the inner cavity.

19. The plastic fence post as recited in claim 18, wherein the first and second grooves each comprise two tabs extending perpendicularly from the inner surface and spaced a desired distance apart.
